(19) United States
(12) Patent Application Publication
(10) Pub. No.: US 2009/0110778 A1
(43) Pub. Date: Apr. 30, 2009

(54) Multi-Component Food or Feed Product

(76) Inventors: Colin H. Muscroft, Glen Carbon, IL (US); Ruben D. Santana, Ballwin, MO (US); Asa M. Gore, St. Louis, MO (US); Jagat N. Persaud, Imperial, MO (US)

Correspondence Address: WENDELL RAY GUFFEY;NESTLE PURINA PETCARE GLOBAL RESOURCES, INC., 1 CHECKERBOARD SQUARE, 11-T, ST. LOUIS, MO, 63164, US

(21) Appl. No.: 12/087,033

(22) PCT Filed: Dec. 28, 2006
(86) PCT No.: PCT/US06/49375

§ 371 Date: Jun. 24, 2008

Related U.S. Application Data
(60) Provisional application No. 60/754,361, filed on Dec. 28, 2005.

(51) Int. Cl. A23K 1/00

(52) U.S. Cl. 426/89

(57) ABSTRACT

Shelf-stable food or animal feed products are disclosed. The products have a substantially cereal based outer shell at least partially surrounding a core, which may be hollow, or filled at least partially with a granular component, a gaseous component, or coextruded with two or more components to form a food product having one or multiple textures, flavors, and colors.

### CROSS-REFERENCE TO RELATED APPLICATIONS

This application is a national stage application under 35 U.S.C. §371 of PCT/US/2006/049375 filed Dec. 28, 2006, which claims priority to U.S. Application No. 60/754,361 filed Dec. 28, 2005, the disclosures of which are incorporated herein by reference.

### FIELD OF THE INVENTION

This invention relates to food or animal feed products. More particularly, it relates to multilayer food or feed products having an outer component and at least one inner component.

### BACKGROUND OF THE INVENTION

Various publications, including patents, published applications, technical articles and scholarly articles may be cited throughout the specification. Each of these cited publications is incorporated by reference herein, in its entirety.

Processed products with more than one component are known for both human food and animal feed. Such products have been used to combine, for example two layers, differing by one or more properties, for example, texture, color, composition, or flavor.

Several granted patents relate generally to the state of the art in multicomponent food or feed products. For instance, U.S. Pat. No. 5,643,623 (the '623 patent) describes a two-component health food product which comprises an antioxidant-containing first component and a discrete second component positioned to protect an in vivo biological antioxidant property of the first component. The antioxidant is a blend of at least two nutritive antioxidants, a nonnutritive antioxidant, and an anti-inflammatory agent. The second component contains a carbohydrate, fat, or protein ingredient, or a combination thereof. The first component can be, for example, sandwiched between the second component, or an internalized core within the second component.

U.S. Pat. No. 6,117,477 (the '477 patent) describes a dual texture animal food product having a soft cream-textured matrix or inner component made of lipid and solid ingredients having no aqueous phase and a moisture content less than about 15%, and an outer component which completely surrounds the inner component and comprises carbohydrate, fat, protein or a combination of those ingredients. The outer component has a moisture content less than about 20%. The product is formed by a co-extrusion process that forms a single, dual-component extrudate. The inner component makes up about 5 to about 50% of the product, by weight.

EP Patent No. EP 1 063 897 B1, which claims priority to the application from which the '477 patent issued, describes a co-extruded dual texture pet or animal food comprising a cereal-based outer shell that completely surrounds a softer inner shell, wherein the total moisture content of the shell component is less than about 20% by weight. The shell contains at least one ingredient comprising a carbohydrate, fat, protein, or combination thereof. The inner component comprises a mixture of lipid and solid ingredients, and has a water activity less than about 0.65 and a total moisture content of less than about 15% by weight.

U.S. Pat. No. 6,254,910 (the '910 patent), which issued from a continuation-in-part application of the aforementioned '477 patent, describes a delivery system for ingredients that are sensitive or unstable during processing. The system comprises the dual texture food product described in '477 patent wherein the soft creamy inner component further comprises an ingredient that is process unstable or sensitive, and the outer component completely surrounds the inner component to maintain the viability of the sensitive ingredient. As in the '477 patent, the product is coextruded as a single, dual-component extrudate.

U.S. Pat. No. 6,312,746 (the '746 patent) issued from an application which was a continuation-in-part of the '910 patent and describes a dual texture animal food product having a soft cream-textured matrix or inner component made of lipid and solid ingredients having a water activity (aw) of less than about 0.65 and a moisture content less than about 15%, and a cereal-based outer shell component which completely surrounds the soft inner component. The shell comprises carbohydrate, fat, protein or a combination of these ingredients and has a moisture content less than about 20%. The product is formed by a co-extrusion process that forms a single, dual-component animal food product.

U.S. Pat. No. 6,827,957 (the '957 patent), which issued from a continuation-in-part application of the aforementioned '746 patent, describes a dual texture non-human or pet food product comprising an extruded cereal-based shell component that completely surrounds the inner co-extruded inner component, and is harder than the inner component. The shell component has a total moisture content of less than 20% by weight and contains at least one ingredient comprising a carbohydrate, fat, protein or combination thereof. The inner component has an aw of less than about 0.65 and a total moisture content of less than about 15% by weight. The inner component comprises a mixture of lipid and solid ingredients, and its lipid content is at least 10% by weight.

U.S. Patent Application Publication No. US 2002/0022079 is a continuation of the '476 patent described above. It describes a dual texture pet or animal food product comprising a soft inner component containing a mixture of lipid and solid ingredients, having an aw of less than about 0.65 and a total moisture content of less than about 15% by weight. The product is also said to comprise a cereal-based shell component, which completely surrounds the soft inner component and contains at least one ingredient comprising a carbohydrate, fat, protein or combination thereof. The shell component has a total moisture content of less than 20% by weight and is formed by co-extrusion of the soft inner component to form a one dual-component food product.

U.S. Patent Application Publication No. US 2004/0052906 describes a two-textured pet food product that has both an inner and an outer component. The inner component has a moisture content of about 12 to 20% and the outer component has a moisture content of about 10 to 30%. As a unit, the two components are said to form a nutritionally complete and shelf-stable pet food. The product is formed to resemble any of a variety of meaty bones for example, drumsticks, pork chops, or t-bones, wherein the inner component is generally bone-like and the outer component is generally meaty. Either or both components can be semi-moist or dry.

European Patent Specification Publication No. 0 088 574 B1 describes an animal food consisting of two formulations, of different composition. The first formulation is a protein meal and a milled cereal mixture, which is shaped as hard closed shell. The second formulation, which has a different consistency from the first, fills at least part of the internal space defined by the closed shell. The inner layer has a lower moisture content that the shell. The specification teaches that the second formulation can be a powder, but is liquid or gel in other embodiments.

U.S. Patent Application Publication No. US 2004/0253342 (the '342 patent application publication) describes a pet food product wherein one to ten pieces of the food provides the complete daily nutritional requirements of an animal. The food is created to resemble meaty-boney structures such as chicken legs or pork chops and is presented to the animal in relatively large pieces that are purportedly fun for the animal, and thereby improve the well-being of the animal and the overall eating experience for the animal and its owner. The food product is designed to force the animal, preferably a dog, to chew, and allows the animal to hold the food product with his appendages while consuming it. The product can have two different attributes, in terms of hardness, brittleness, toughness and density, corresponding to the meaty portion and the bony portion, or it can be of a single consistency.

Related U.S. Patent Application Publication No. US 2005/0181097, which is a continuation in part of the aforementioned '342 patent application publication, describes a pet food in which a number of pieces between one and fifteen provides the complete and balanced daily nutritional requirements of an animal. Each piece has a caloric content of between 50 and 2500 kcal. The inner and outer components can differ in attributes such as hardness, brittleness, toughness, density, caloric density, calories per gram, color, or flavor.

U.S. Patent Application Publication No. US 2005/0084517 describes a dual textured pet food product which is useful for the treatment of hairballs or the accumulation of hair in the stool. The product comprises a shell which completely surrounds an inner component. The shell is harder than the inner component, and comprises a dietary fiber as well as an additional source of soluble and insoluble fiber. The softer inner component comprises a lubricant such as petrolatum or mineral oil.

While the aforementioned patents describe certain advances in the art of multicomponent edible products, a need remains for innovative products that can provide alternative or additional features and advantages. For example, a need exists for products capable of multiple variation in texture and substance, as well as products having improved functional properties, such as flavor, aroma, color, texture, mouth-feel, palatability, satiety, emulsification, hydration properties, water activity stabilization, or microbial control.

### SUMMARY OF THE INVENTION

One aspect of the invention features an extruded food product comprising a shelf-stable shell at least partially surrounding a hollow core area, wherein the shell comprises an outer surface area and an inner surface area, said surface areas adapted to allow rehydration of the food product upon exposure to a wetting agent, said surface areas accessible to the wetting agent. In various embodiments, the rehydration occurs at a faster rate or to a greater extent, or both, than in a comparably formulated food lacking the inner surface area. The food product may also retain more of the wetting agent after a predetermined time than does a comparably formulated food lacking the inner surface area. In certain embodiments, the shelf-stable shell partially, but not entirely surrounds, the hollow core area.

In certain embodiments, the food product is formulated to provide the complete macro and micro nutritional requirements of a mammal. In one embodiment, it may be adapted for consumption by a weanling mammal, for example, a puppy or a kitten. In another embodiment, the food product is adapted for use by a mammal with a limited ability to chew relative to healthy mammal of the same species. Specific formulations are for a dog or a cat, more specifically, an elderly dog or cat. In another embodiment, the food product is formulated for a mammal that is has compromised health, or is recovering from illness or surgery.

In certain embodiments, the food product is cereal-based. It also may be less dense that a comparably formulated food product lacking the inner surface. Further, it may require as much as 50% less energy to break than a comparably formulated food product lacking the inner surface. In another embodiment, the food product has improved palatability over a comparably formulated food product lacking the inner surface.

Another aspect of the invention features an extruded food product comprising a shelf-stable shell at least partially but not entirely surrounding a core area. The shell comprises an outer surface area and an inner surface area, and the surface areas are adapted to allow rehydration of the food product upon exposure to a wetting agent, wherein the core area is at least partially filled with one or more additional ingredients, or a mixture thereof, the additional ingredients being added either during manufacture of the shelf-stable shell, or at a time subsequent to the extrusion of said shell, wherein the food product rehydrates upon exposure to a wetting agent, said wetting agent having at least partial access to both the outer surface area and the inner surface area of the extruded shell. In various embodiments, the rehydration occurs at a faster rate or to a greater extent, or both, than in a comparably formulated food lacking the inner surface area. The food product may also retain more of the wetting agent after a predetermined time than does a comparably formulated food lacking the inner surface area.

In various embodiments, at least one of the one or more additional ingredients, or a mixture thereof, are sprayed, stuffed, injected, or pumped into the core defined by the shell. The one or more additional ingredients, or a mixture thereof, comprises one or more of a product or by-product that is of animal, plant, or microbial origin. In particular embodiments, additional ingredients or a mixture thereof is an animal product or by-product that is a dairy-, meat, or egg-based or derived ingredient. In other embodiments, it is a plant product or by-product that is derived from a seed, leaf, fruit, vegetable, tuber, bulb, or stem. In still other embodiments, it may be a microbial product or by-product that is derived from a yeast, algae, bacterium, or mold.

The at least one of the one or more additional ingredients may also comprise a powder or granular ingredient, such as a milk powder, whey powder, egg powder, grape powder, purple corn meal, green algae, blueberries, tallow, or a palatability booster digest powder. In other embodiments, at least one of the additional ingredients provides a functional property, such as flavor, aroma, color, texture, mouth-feel, palatability, satiety, emulsification, hydration properties, water activity stabilization, or microbial control.

In other embodiments, the food product comprises more than two textures, colors, flavors, or a combination thereof. The outer shell typically has a moisture content by weight of less than about 14% and a water activity of less than about 0.63, and is resistant to mold growth. In another embodiment, the shell has a moisture content by weight of up to about 25%, and further comprises humectants. These food products are also resistant to mold growth.

Another aspect of the invention features an extruded food product comprising a shelf-stable shell surrounding a core area, wherein the core area is at least partially filled with one or more granular ingredients, or a mixture thereof, the additional ingredients being added during manufacture of the shelf-stable shell. In certain embodiments, the food product comprises more than two textures, colors, flavors, or a combination thereof. The outer shell typically has a moisture content by weight of less than about 14% and a water activity of less than about 0.63, and is resistant to mold growth. In another embodiment, the shell has a moisture content by weight of up to about 25%, and further comprises humectants. These food products are also resistant to mold growth.

In certain embodiments, at least one of the one or more granular ingredients is plant-derived. In other embodiments, at least one of the granular ingredients is animal derived or derived from a microorganism. The particle size of the granules is typically greater than about 150μ in mean diameter.

The above described food product may be a breakfast food, a snack food, a pet food, or a pet treat. In certain embodiments, the product is at least about 26% protein by weight and at least about 10% fat by weight as determined by standard methods for food analysis.

Another aspect of the invention features an extruded food product comprising a shelf-stable shell surrounding a core area, wherein the core area is at least partially filled with one or more gaseous ingredients, or a mixture of such ingredients, the gaseous ingredients being added either during manufacture of the shelf-stable shell, or after. In certain embodiments, the gaseous ingredient comprises at least one aroma component. In one embodiment, the aroma is substantially released only upon breakage of the outer shell. In one embodiment, the aroma component is compartmentalized within the shell as a convenience to a consumer who finds the aroma objectionable. In another embodiment, the aroma component is compartmentalized within the shell to maximize a perception of the aroma at a time of consumption.

The outer shell typically has a moisture content by weight of less than about 14% and a water activity of less than about 0.63, and is resistant to mold growth. In another embodiment, the shell has a moisture content by weight of up to about 25%, and further comprises humectants. These food products are also resistant to mold growth.

Another aspect of the invention features an extruded food product comprising a shelf-stable cereal-based shell surrounding a core area, wherein the core area is at least partially filled with one or more ingredients, or one or more mixtures of such ingredients, the ingredients or mixtures being co-extruded with the shelf-stable shell. The shell typically has a moisture content by weight of less than about 14% and a water activity of less than about 0.63, and is resistant to mold growth. In another embodiment, the shell has a moisture content by weight of up to about 25%, and further comprises humectants. These food products are also resistant to mold growth.

In various embodiments, the food product is a breakfast food, a snack food, a pet food, or a pet treat. In certain embodiments, the food product provides a nutritionally balanced diet for a mammal. In specific embodiments, it comprises at least about 26% protein by weight and at least about 10% fat by weight as determined by accepted methods of food analysis.

In certain embodiments, the food product comprises more than two textures, colors, flavors, or a combination thereof. The ingredients may be plant-derived, animal-derived, or microbial-derived. The ingredients may be in the form of a solid, a semisolid, a meal, a slurry, a granule, a powder, a plasma, a gel, a liquid, or a gas, and may include meat or a meat by-product, fish or a fish by-product, seafood or a seafood by-product, egg or egg-based product, milk, cheese, butter, whey, vegetable, fruit, seed or portion thereof, a microbial extract or by-product, a humectant, an acidifier, an antimicrobial, an antimycotic, a sweetener, a gelling agent, an antioxidant, a spice, a flavoring, or an aroma.

Other features and advantages of the invention will be understood by reference to the detailed description, examples and drawings set forth herein.

### BRIEF DESCRIPTION OF THE DRAWINGS

FIG. 1: Depicts the water absorption of a food product having a hollow core as compared with other food products. The solid black bars represent two comparable pet food formulations, one as a traditional round, solid kibble, the other having a hollow core as “Empty Kibble”. The Empty Kibble absorbed and retained more water than the comparable formulation.

FIG. 2: Water retention is greater for the food product having a hollow core. Depicted is the water drained from a pet food product having a hollow core (“Empty Kibble”) compared to that drained from the comparably formulated traditional pet food product (“Solid Kibble”) after a fixed amount of time.

FIG. 3: Graph of palatability of “Empty Kibble” versus “Solid Kibble” using a weaning formula in dogs.

FIG. 4: Graph of palatability of “Empty Kibble” versus “Solid Kibble” using a traditional puppy food.

FIG. 5: Graph of palatability of “Empty Kibble” versus “Solid” or “Clover” Kibble in cats.

### DETAILED DESCRIPTION OF ILLUSTRATIVE EMBODIMENTS

### Food Product with Enhanced Hydration Properties

In one aspect, the invention features a shelf-stable, dry food product with enhanced properties for rehydrating. The food product comprises a shelf-stable shell at least partially surrounding a hollow core area. The size and shape of the food product can be quite flexible, both in terms of the outer dry shell and the hollow core. In one embodiment, the shell is generally or substantially spherical, and the hollow core area is also substantially spherical. In another embodiment, the substantially spherical food product is not a complete, closed sphere, but rather is partially open to the surroundings. In other embodiments, the food product may be completely sealed with the hollow core completely surrounded by the shell. The food product can be a breakfast food, a snack food or a pet or animal food, but generally is of type that is usually wetted with a liquid or “wetting agent,” for example breakfast cereal-type products and dry pet food products. Wetting agents for the food product are typically applied by the consumer, or the person preparing the food product for consumption by a pet or animal. Wetting agents can include any nutritive or nonnutritive food-grade or potable liquid, for example water, milk (e.g. breast milk, cow's milk), juice or juice products, and the like. In a preferred embodiment, an open area in the shell provides sufficient access for an amount of wetting agent, such as water, to contact the inner surface of the shell, for example to contribute to the improved hydration properties of the food product. In other embodiments, the shell is another shape, for example but not limited to, at least substantially cylindrical, barrel-shaped, conical, double conical, diamond-shaped, cup-shape, torical, supertorical, superspherical, oval, elliptical, triangular, rectangular, cubical, polygonal, or such other shape as is deemed appropriate for the application of the food product. The food product is commonly made as “pillow”-shaped product of various sizes. In certain embodiments, a pillow-shaped product can be easily formed from a substantially cylindrical shape which is at least partially flattened with the ends pinched together or folded in—for example while separating an extrudate into smaller pieces. In some instances, a desirable shape is based on a technical determination or functional property. In other instances, the shape may be selected based on marketing data, while in yet other embodiments, a shape is selected for primarily or solely aesthetic purposes. Pillow-shaped food products are preferred for certain embodiments, for example in the area of pet foods. A pillow shaped food product may be of rectangular or any other cross-sectional area.

In one embodiment, the food product comprises a unique texture. The food product, in part because of its texture, and in part because of its configuration or shape—i.e. the surface area available for contact with a wetting agent, has the quality of being easy to at least partially hydrate (rehydrate) or even to soak. In one embodiment the food product absorbs water at a faster rate than a comparable product lacking the unique texture or increased surface area in contact with the wetting agent. In another embodiment, the food product can absorb more total wetting agent than a comparable food product lacking the features of the inventive food product. In yet another embodiment the food product retains more of the rehydrating wetting agent in a given time period that a product of comparable formulation in a traditional shape (e.g. solid), for example lacking the inner surface area of the shell.

In another embodiment, the food product is easier to chew than a product that does not have a hollow, or at least partially hollow core, or a product that does not wet as easily. This is especially useful in certain food products, for example in providing transition food to babies, pets, or mammals being weaned from their mother's milk. The food product of the instant invention allows the parent, owner, or breeder to quickly and easily prepare a meal with an appealing, soft or porridge-like consistency for the young child, pet (e.g. puppy or kitten), or mammal who has not fully transitioned from mother's milk or formula to solid food, or has just begun to do so. The food product can be formulated to meet or exceed the nutritional needs of the intended recipient, and can be further formulated to be readily digestible, low residue, or have other dietary, nutritional, or health benefits.

A food product with enhanced rehydration properties is also very useful for example for individuals, pets, or animals who are older, or who may have difficulty chewing because of oral conditions such as teeth problems and the like. It is also beneficial for those who are weak from illness or perhaps are post-surgical. Again, the food product here can be formulated to meet the nutritional needs of the intended recipient of the food product, and can provide improved palatability.

In a detailed embodiment, the rehydration properties allow the food to absorb up to 10% more wetting agent than a product of the same formulation in a traditional solid shape—for example a food product of the invention as a substantially spherical shape surrounding a substantially spherical hollow core compared to a solid round shape. More preferably, the food product of the invention can absorb at least about 20%, 30%, or 40% more wetting agent than the traditional shaped food product. Even more preferably the food product of the invention can absorb up to about 50% or more additional wetting agent as compared with the same formula in a traditional solid shape.

The food product can be manufactured with a variety of properties, for example textures, shapes, flavors, aromas, and colors. In one embodiment, the food product is manufactured from a slurry. In certain embodiments, for example, for pet or animal foods, the slurry comprises a high fat content and high protein content. Formulas to create a slurry of such content as would be useful or satisfactory for feeding for example dogs, puppies, cats, kittens, and other animals are generally known in the art for the manufacture of pet foods, or can be determined from the literature on the specific mammal or animal of interest.

The food product produced in accordance with various aspects of the invention is preferably lighter than a comparable traditional food product, i.e. the food product of the invention is less dense. In one embodiment, the force required to break the food product of the invention is at least about 10% less than that required to break a traditional food product of comparable formulation, as determined by physical measurement of the force, for example on an Instron mechanical testing device, or the like. More preferably, the food product according to this aspect of the invention requires at least about 20%, 30% or even 40% less force for breaking than does a comparably formulated tradition food product. Still more preferable is a requirement for at least about 50% or more, reduced force required for breaking the inventive product. Preferably, the reduced density of the food product provided herein contributes, at least in part to the requirement for less force for breaking the instant food product.

Not only can the food product as provided herein offer improved hydration properties, such as soakability, and a requirement for reduced breaking force, but the palatability is increased as well. In animal studies with the food product, the palatability is substantially increased. In some embodiments the palatability is increased by about 10-20% over a comparable food product of conventional formulations and manufacture. More preferably the palatability is increased by about 20% or 25% up to 33%. Still more preferably, the palatability of the food products according to the invention is increased by about 30-50% or more. Still more preferred are food products wherein the palatability is increased by at least about 50% or 60% up to 75% or even 100% compared to conventional food product of comparable formulation.

### Enhanced Hydrating Food Product with Additions

In another aspect of the invention, a food product with enhanced properties for rehydration, as above, is provided and the hollow core is at least partially filled with one or more useful additives either during the manufacture of the food product, or in a further processing step at a time subsequent to the formation of the shell. Thus the invention provides a cereal-based, extruded food product with one or more textures. The core is preferably not filled 100%, but rather some surface area of the inner portion of the shell remain accessible to a wetting agent to maximize rehydration efficiencies—such as the time and the extent of rehydration.

In one embodiment, the food product is at least partially filled with at least one additional edible component, preferably a nutritive component, though the additional component can provide functional properties, such as flavor, aroma, texture, mouthfeel, satiety value, or color, or nutraceutical properties, or even pharmaceutical or medical properties. The additional component can be added after the manufacture of the food product, for example by placing, spraying, stuffing, injecting, pumping, dispersing, or gravity feeding into the hollow core area of the product. In certain embodiments, the additional component can be added in small batch operations, or even manually to allow for a semi- or fully-customized food product. Applications for such products can include customizing to meet specialized dietary or medical needs of an individual, or simply customizing in response to customer preference. For example, a snack food can be prepared according the instant invention wherein the hollow core is at least partially filled according to customer selection at the point of sale. An easy to rehydrate animal or pet food can be prepared according to the instant invention wherein the additional component to be placed in the shell is customized to meet specialized dietary or medical needs of the pet, for example in accordance with a veterinarian's advice or prescription.

In other embodiments, one or more additional components can be added during the manufacture or processing of the food product. This is particularly useful for larger scale applications of the food product. For such embodiments, the added ingredients can for example be co-extruded, with or without heating, into the core area of the shell as the shell is formed around it, or they can be added by other means, including after the complete formation of the shell.

Examples of useful components or ingredients that can be added to the food product with improved rehydration properties provided herein include, but are not limited to, nutritive components in addition to those found in the shell, for example additional sources of fat, or even particular lipids or classes thereof, carbohydrates, protein, fiber of either nutritive or nonnutritive, soluble or insoluble types, vitamins, antioxidants, as well as ingredients which tend to provide other desirable qualities, such as flavor, aroma, texture, mouth-feel, satiety, palatability or stimulation or suppression of appetite, and combinations of any of the foregoing. In short, the additional component can include a single ingredient or a mixture of any number of ingredients useful for purposes related to the health or enjoyment of the person, pet, or animal consuming the food product, including, for example, increasing palatability or promoting the consumption of the food, or making the food product easier to handle or use for a human providing it to an animal or pet.

For example, in some cases, an additive which is used for enhancing the health of a weanling pet or animal is sprayed or stuffed or applied into the void area of the shell. In another embodiment, an additive that is likely to be selectively or preferentially avoided by a pet or animal if provided separately to the animal, or when the item is mixed in with the usual food, is readily taken when placed inside the food product according to the invention.

In another embodiment, the food product includes an additional component or ingredient which is inconvenient for a human providing the food product to an animal or pet to separately provide to the animal or pet, or to manually mix in to the animal's or pet's food at the time the food product is served. In some cases, an ingredient can be inconvenient because it is unpleasant with respect to smell or appearance, or because of some other undesirable property such as messiness, stickiness, or difficulty in dispensing in proper amounts. In other cases, the added component or ingredient is not pleasant for the humans to handle or smell, although it may be appealing, even highly so, to the pet or animal.

In one embodiment, the added ingredient includes at least one of a product or by-product of a plant, animal, or microbial source. In the case of plants, the ingredient comprises at least a part of the plant—for example at least a part of a leaf, a stem, a fruit, a vegetable, a seed, or some combination thereof. In the case of seeds, the material may be for example a flour or a protein-containing meal or some other fraction. In certain embodiments, the seeds can be germinated or sprouted to various degrees, or the plants can be malted. Fruits can provide color, flavor, sweetness, soluble fiber and the like, in addition to various phytonutrients for which plants are the known. Such phytonutrients can be part of the use of a plant ingredient as a nutraceutical—e.g. a nutrient with an important health benefit—for example antioxidants, vitamins, co-factors and precursors. Such nutraceuticals may have protective benefits in minimizing the prevalence or severity of certain diseases or reducing recognized risks to health. In the case of animal sources, the ingredient can comprise, at least in part, a dairy product or by-product, a meat product or by-product, or a product or by-product of some other part of the animal in food processing either as a nutritive component, or functionally. Whole eggs or portions thereof are also useful as ingredients for adding to the food product of the invention, preferably in a powdered form.

The added ingredient or ingredients may be added in powder form after the production of the shells in one embodiment. Granular ingredients or mixtures of granular ingredients can also conveniently be used to add to the shells. Ingredients in the form of meals can also be used easily. In the case of vegetable or fruit matter, the ingredient can be added as a dried material such as a powder or granular form, or as a puree, slurry or other form having more or less water present, depending on the application and the relation of when the ingredient is added to the product to when the product is to be served. A wetter ingredient could be added close to when the product is to be served. Mixture of powdered, granular, and other ingredients can be used as well as additive ingredients for use in filling the food product in accordance with the invention. Powdered ingredients are readily available and are useful herein. In one embodiment, the food product in accordance with this aspect of the invention provides an optimum particle size and granular texture. Particle size is particularly an important feature of any ingredient mix that is to undergo reconstitution with water or another wetting agent. The smaller the particle size, the more surface area is available for water absorption. Powders that are too fine tend to form more lumps and requires more time and energy to properly disperse. Too many large particles make the dispersion heavier, and seemingly gritty. Optimum distribution of particle size is preferred to get the best acceptability, especially in weanling animals, or in the older populations of animals. In one example, particle-size distribution of weaning food ingredients and formulations about half of the particles are larger than 250μ and half are smaller. Some ingredient particles tend to be finer than others, some are all larger than 250μ. Some commercial weaning foods have particles distributions wherein about three quarters (75%) of the particles are larger than 250μ. These produce fewer lumps when mixed in water. The skilled artisan will understand the various tradeoffs and considerations in avoiding powdered ingredient substantially smaller than 50μ, or 100μ. In one embodiment, preferred granular ingredients have particle sizes of about 100μ or larger, for example 100μ, 120μ, 150μ, 180μ, 200μ, 250μ and even somewhat larger.

Microbial ingredients can also be used with the present food products as a additive ingredient. For example, various microbial protein sources and vitamin sources are known to be useful in pet and animal food products. In addition, certain lipids and other useful nutrients can be produced in desirable microbes for inclusion with food products. In one embodiment, algae, for example green algae, are used to produce useful ingredients for inclusion in or addition to the food product. Such algal products can be added for example as a powder.

Examples of particular ingredients for placing, stuffing, spraying, injecting, or filling by any manner into the shells include functional powders such as milk, whey, and egg powders, and functional foods such as green algae, fruit powder (e.g. grape powder), or fruit including colored berries such as blue berries, as well as corn meal (e.g. purple corn meal), soy meal, and fish meal. Palatability boosters including digests and tallow can also be used to at least partially fill the core of the food product.

The food product can comprise a single texture, or more generally can comprise two or more textures. Where a single texture is desired, the additional components in the outershell are of a similar texture from the outer shell, such that the textures are not readily distinguishable by the consumer. Where two or multiple textures are desired in the final product, the ingredients can be selected such that each desired texture is sufficiently different as to be likely distinguished by the consumer of the food (whether human, pet or other animal). Thus, where the outer shell preferably has a crunchy texture which is relatively easy to break, the inner fill components can for example consist of other textures that are softer or harder, with more or less yield, and which seem moister or drier to the consumer. There are a large number of textural attributes which can be varied according to the ultimate end-product desired. The skilled artisan will appreciate the many texture attributes available and will generally understand how the desired attributes can be accomplished in a food product according to the invention.

Because the shell can be any size and shape, as discussed above, and formulated with a wide degree of flexibility, the skilled artisan will appreciate that there are many uses for such a shelf-stable, rapidly-rehydrating, extruded shell. It is now possible to envision breakfast foods and snack foods for humans, as well as pet or animal foods, or treats, all of which are contemplated for use herein. The skilled food technologists will accordingly appreciate that the instant invention is not limited to the precise embodiments described herein, but is capable of broad variation consistent with the teachings provided.

### Food Product with Granular Filling Component

In another of its several aspects, the invention provides a shelf-stable food product comprising a cereal-based extruded shell at least partially surrounding a granular filling component with a moisture content lower than that of the shell. To prevent problems associated with spoilage, deterioration, microbial growth, or other loss of quality due to high moisture content, for example the growth of mold, the water activity of the shell is preferably maintained at less than about 0.8, 0.75, 0.7, or even 0.67. More preferably, the water activity of the shell is less than about 0.66, 0.65, or 0.64. A water activity for the shell of less than about 0.63, 0.62, 0.61, 0.60 is also useful for the food product. In one embodiment, the shell has a moisture content lower than about 14% by weight. The water activity, aw, of such a shell is preferably low enough to prevent deterioration such as molding, and low enough to render the shell and the product shelf-stable. In another embodiment, the shell is a semi-moist extruded shell comprising a moisture content of greater than about 20% and up to about 25% by weight. To lower the water activity and minimize the problems associated with higher water activity, the semi-moist food product is protected through the use of humectants and other vapor pressure adjusting materials, which may also be used in combination with preservatives such as antimycotics. Examples of humectants include glycerol, sorbitol and various sugars, the use of which is understood by those of skill in the art of formulating semi-moist, shelf-stable food products. Salt and other compounds can also be added to help reduce the vapor pressure and water activity of the food product.

The shell of the food products provided herein can comprise a small or large percentage of the overall product—for example the shell could comprise from about 30% to at least about 90% of the total food product. Depending on the nature and function of the granular filling component or ingredient, more or less shell component may be desirable.

The center composition of the shell is a granular material in whole or in part which is encased in the outer cereal-based shell. In various preferred embodiments, the center fill ingredients are completely encased by the shell ingredients after extrusion, i.e. the inner fill and the outer shell are co-extruded to form the food product. The center, or filled portion of the shell can comprise carbohydrate, lipid, protein, or fiber, or a mixture of the foregoing. The ingredients of the center fill can be moist or dry, although it is presently preferred that, the material have a moisture content less that about 14% and an aw of about 0.6 or less, or that the fill have up to about 25% moisture and utilize humectants and aw-reducing components and antimycotics to maximize shelf-stability. It is also preferable that the center fill components or mixture, on the whole, have a lower moisture content than the outer shell. Despite the broad possible compositions of the center fill components, it is intended nonetheless that the texture of the fill ingredient be at least partially granular, and not predominantly or excessively powdery or creamy.

While powdered ingredients are readily available, and creamy fills are known in the art of dual textured foods, preferably the food product in accordance with this aspect of the invention provides an optimum particle size and granular texture. Optimum distribution of particle size is preferred. In one embodiment, preferred granular ingredients predominantly have particle sizes of about 100μ or larger, for example 100μ, 120μ, 150μ, 180μ, 200μ, 250μ and even somewhat larger.

In one embodiment the shell is at least partially filled with a granular material, including for example, a single ingredient, or mixture of ingredients which comprise, a protein, a fat, a carbohydrate, or a fiber, for example a soluble fiber, or a combination of the foregoing. The outer shell as used herein can completely encase the granular ingredient or ingredients.

Examples of the granular material that could be used to form a filling for the food product are plant-based ingredients such as corn meal, soy products (such as soy meal), oat meal, crushed or granulated cereals, crushed or granulated herbs or other flavoring components, such as dry herbs, vegetable, fruit, or seed-derived components, fiber-containing material, animal products or by-products, for example fish meal or other source of animal protein, or the like. The granular material need not be naturally occurring, but could include processed food or feed of a granular nature or texture.

In one embodiment, the granular material is crushed herbs providing flavor, aroma, and other functional properties to the final food product composition. Each of the final ingredients preferably provides at least a nutritive value, a functional value, or some other value to the final product. In another embodiment, the granular additive is a corn meal or a corn product or by-product. Granular forms of ingredients such as milk, cheese, eggs, or whey can also be used. The center fill components can also comprise granulated dehydrated meat, vegetables, fruits, and the like. Fish and fish by-products can also be provided as granular material to used as, or added to the center fill composition.

The applications of the granular-filled food product will be apparent to the skilled artisan. The product, for example provides additional benefits if the granular center fill component has a particularly strong or objectionable aroma during storage or prior to eating, not only will the strong aroma be encased so as not create odor problems, the crushing of the food at the time of consumption will release the aroma in a concentrated and more enjoyable form at the time of consumption. For example, in pet foods certain meat or fish products have strong aroma which are appealing to the pet, but not to the owner. For human foods, certain cheeses and items like garlic are strong and can be objectionable if remaining too long after a snack has been consumed, the food product encases the granular cheese or garlic so that its aroma is not problematic prior to or after consumption. Similarly, certain aromatic foods are highly appreciated by persons of one cultural background but objectionable to persons of a another cultural background. Thus the food product of the invention allows a food, such as snack food to contain its potentially objectionable aromas until consumption at which time the enjoyment of the consumer is maximized as the preserved aroma is released upon disruption of the outer shell.

In addition to the appeal of aroma control, the food product of the invention allows combinations of flavor and color to be used, as the granular filling can have one or more completely different flavor and color from that of the shell. This allows the skilled artisan to create new breakfast foods, snack foods, pet foods and the like with a great variety of appeal in terms of aroma, flavor, and color.

In the case of pet or animals foods, it is preferable that the overall composition or ingredient mix provide a nutritionally complete food. For example, the composition of the food product should be generally such that the product is about 26% or more protein by weight and about 10% or more fat by weight. In the case of pet treats or human snack foods, it is not necessary that the food product be nutritionally complete, but rather can provide useful supplementation with various macro and micro nutrients as is desired and useful.

As with flavor and color, it is also to be noted that the food product according to this aspect of the invention will provide two or more textures, depending on the nature of the granular center fill. A combination or mixture of different ingredients having particles of different sizes and textures will create a multitextured fill, while a fill having fairly uniform particles of a single texture will result in a food having two textures—that of the shell and that of the fill—which are simultaneously in the mouth.

Because of the varied aromas, flavors, colors and textures possible with the food product with granular filling as provided herein, the palatability is high and the enjoyment and interest are also increased. This is particularly useful in feeding and care of pets and animals, wherein boredom can lead to reduced consumption.

### Food Product Filled with Gaseous or Aromatic Filling Component

In yet another aspect, the invention provides a shelf-stable food product comprising a cereal-based extruded shell completely surrounding a hollow core wherein the core contains a gaseous filling or aroma other than air. The shell can be dry, such that its moisture content is less than about 14% by weight, and its water activity is less than about 0.60. Alternatively, the shell can be a semi-moist shell having greater than 15% or 20% moisture content by weight, and even up to about 25% moisture content by weight. As above, for semi-moist outer shells, humectants and other additives are used to reduce water activity, control microbial growth and other deteriorative processes, so as to maximize stability of the food product. The food product filled with a gaseous filling or aroma generally consists of only one texture. In certain embodiments, the gaseous component may provide an additional experience in the mouth—however, this experience is not generally deemed a separate texture. For example, a snack food may have a certain residual carbon dioxide or other gas which can be released and experienced in the mouth.

In one embodiment, the semi-moist outer shell is extruded in a environment comprising the gaseous filling or aroma to be encased in the shell. In another embodiment, the shell is injected with the gaseous filling or aroma after its formation. In yet another embodiment the extrudate is formed as hollow length which is flushed and filled with the gaseous or aroma components as the individual pieces are cut to size and sealed.

The instant product differs from currently available products that comprise only air. The food product made in accordance with this aspect of the invention provides for any gaseous filling other than air. The gaseous filling can comprise a single gas, or more preferably a mixture of gases, such as carrier gases and an aroma component. In another embodiment, one or more solid or semisolid components are added which evolve a gas upon mixing in the shell.

In one embodiment, the carrier gas gradually disperses prior to packaging or during storage, but the aroma component remains associated with the cereal-based shell. In certain embodiments the gas may be completely inert, in other embodiments the gas may be incorporated to help evolve flavor components which are present, for example as precursors in the cereal shell—i.e. through desired redox reactions.

In terms of aroma, the aroma can be any aroma which is useful to improving the functional properties. As the skilled artisan will appreciate, the palatability can be increased through the use of aromas that are appetizing to the intended recipient of the food. For example, especially useful are various meat and fish aromas, as well as cheese and other dairy product aromas. In some cases the aromas can be naturally derived, while in other cases it is easier and more effective to utilize synthetic compounds and formulations. Particular components are known to the skilled flavor and aroma chemist to be significant notes in various appealing foods. Meaty aromas can include for example the aromas of red meat, poultry, pork or the like—whether cooked, or raw, intact or comminuted, fresh or aged to various extents, bones and marrow, and the like. Dairy aromas can include those of milk, butter, cheese, yogurt, other fermented or fresh dairy product. Aromas of vegetables, fruits are also useful for certain embodiments herein, as are other earthy aromas such as those associated with mushrooms or the like, and various aromas which may be described as “smoky”. Fishy aromas can relate to fish or parts thereof, fresh or aged, cooked or raw, as well as to other seafood and stock prepared therefrom. Aromas generated from microbial fermentations and other sources also may have utility in the food product provided herein.

The gas component itself may comprise other minor and micro-components which themselves may influence palatability—such as specific flavors, or the overall flavor of the final food product.

### Food Product with Two or More Filling Components

Also provided herein are shelf-stable food products which comprise a cereal-based extruded outer shell defining and encasing a core, wherein the core is filled with at least two additional components. The extruded food product in accordance with the foregoing may have one, two, or even multiple textures to the consumer. The product likewise can have one or more colors, and one or more flavors.

As above, the outer shell can be dry, wherein its moisture content is less than about 14% by weight, and its water activity is less than about 0.60. In other embodiments, the shell can be semi-moist, with a moisture content by weight of at least 15% or 20%, up to about 25% moisture content by weight. Here, too, humectants and other additives are used to reduce water activity, control microbial growth and other deteriorative processes, so as to maximize stability of the food product where the shell is semi-moist and might support deterioration or mold growth.

The ingredients for filling the center can be similar to or even identical to the shell composition, with further additions such as humectants, plasticizers, flavorings, fats, emulsifiers, or powdered ingredients such as powdered milk, eggs or whey. The center filling ingredients can comprise one or more powders, granular materials, pastes, high solid gels, savory gels, meats, fish, eggs, vegetables, tubers, fruits, seeds, meat-based and/or fish-based formulas, slurries, meals, plasmas, gases and aromas. One or more of the ingredients can also comprise an additive such as a humectant, a stabilizer, an emulsifier, an acidifier, an antimicrobial, an antioxidant, a preservative, or an antimycotic.

In one embodiment, the product is a coextruded product wherein the outer cereal-based shell is extruded around the components of the center filling, which are extruded in to the center in either a hot or cooked form, or in a cold or uncooked form, depending on the particular application and formulations being used. The skilled artisan, being familiar with formulating food products will appreciate which components should be extruded hot or cooked, and which may be used cold or uncooked. In certain embodiments the multiple components or ingredients of the center fill material are allowed to intermix during the extrusion process, while in other embodiments they are separately fed into the cereal-based outer shell during the manufacture or processing operations. Thus, any method of manufacture consistent with the foregoing may be used, twin-screw or multiple extruders may be used, or other means of getting the shell to encase the contents of the center. Where multiple textures, especially more than two, are desired, it is preferable to prevent the various ingredients of the center fill from forming a homogenous mixture prior to the extrusion operation. In certain cases, the various textures of the ingredients in the final products will be distinguishable because the ingredients vary in particle size, hardness, yield and the like therefore it is not necessary to maintain the ingredients completely separate during the manufacture or extrusion process. In other cases, where certain ingredients are distinguishable only where maintained separately throughout the manufacture of the food product, it is more important to maintain them separately.

Not only is it possible to produce a multifilled food product consistent with the foregoing, several configurations can conveniently be produced. In one embodiment, the multiple filling components are blended as a uniform or nonuniform mixture for use as a filling ingredient. More preferably, one or more of the ingredients for the center area are maintained separately and even filled separately into the center of the outer shell. The ingredients of the food product can be produced in concentric layer wherein for example an outer layer in extruded, and middle and inner layers are coextruded into the outer layer. The product is made as a continuous unit and cut or separated into pieces of desired size. The die used to extrude the concentric layers can produce extrude of any cross section shape, although basic shapes facilitate the process.

In addition to the food product wherein the filling ingredients are coextruded in a concentric fashion, the food product can be made wherein the fill ingredients are coextruded as separate, adjacent, but nonconcentric streams into the outer cereal-based extrudate stream. This will result in a product that has an outer cereal-based shell that has adjacent, connected but substantially distinct areas within the shell wherein each of the separate ingredients or mixtures thereof is located. Thus, in this embodiment, the separate streams of fill ingredients are in parallel but not in concentric relationship to each other. Other configurations for manufacturing the product, or combinations of the foregoing, are considered within the scope of the present invention.

The following examples are provided to describe the invention in greater detail. They are intended to illustrate, not to limit, the invention.

### Example 1

### Soakability (Hydration) of Improved Food Product

Aim: To evaluate the hydration of kibbles and flakes. This procedure was designed to measure the soakability of kibbles and flakes. Soakability level is defined as the mass of water needed to hydrate a given weight of a sample in a given time.

### Materials and Methods

A known weight of the sample was immersed in an excess, but known volume of water at 40° C. for a precise time (usually 3 minutes). After filtration (Buchner filter), the volume of water unabsorbed by the sample was measured. The volume absorbed by the sample was determined by difference. Each sample was measured twice.

The dry matter content of the sample was determined before the soakability procedure. Before use, a Büchner filter was prehydrated with an excess of water. The excess of water was been eliminated before use. 100 grams dry matter (DM) of the sample to be measured were placed in a 600 ml beaker. Water at 40° C. (+/−1° C.) was added at either 250 ml (for kibble) or 500 ml (for flakes). The sample must remain submersed during the entire hydration time, e.g., the entire 3 minutes. Where needed, the sample was kept submerged with a beaker. After the hydration time was complete (e.g. 3 minutes), the sample and water were filtered through the Büchner filter and the filtrate was collected and its volume measured. The filter was allowed to drip for 3 minutes.

### Calculations

Hydration was calculated as follows:

For Kibble: % Hydration=(250−V) ml/100 g of dry matter, where V=volume of non absorbed water.

For Flakes: % Hydration=(500−V) ml/of dry matter, where V=volume of non absorbed water

For each sample, the average value, the standard deviation, and the coefficient of variation were calculated as follows:

Average, X=(ΣXi)/n

Standard deviation, ET=(Σ(Xi−X)²/(n−1))^{1/2}

Coefficient of Variation, CV=ET/X×100;
where Xi=value of each measure for a given sample, and n=number of measures. The units are calculated as Volume of absorbed water per 100 g of dry matter.

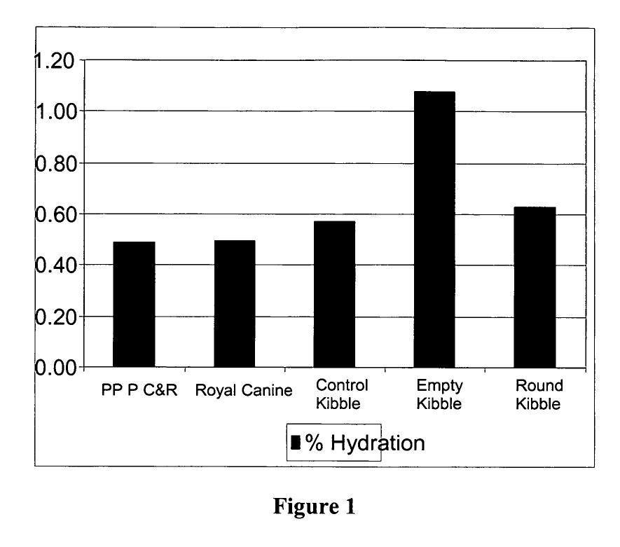

The results are presented in FIG. 1.

### Example 2

### Soakability as a Measure of the Practical Advantages and End-User/Owner Appeal of the Improved Food Product

A second soakability test was developed in house to observe the visible difference in soakability. Objective: Measure the soakability of water into a dry pet food sample in a given time. Soakability is the weight of water absorbed into the food in a given time.

### Materials and Methods

A clear dry plastic bowl was placed on a scale and the scale was zeroed. 300 grams of dry food product were placed into the bowl. The bowl with food product was removed from scale and placed onto a bench top appropriate for viewing and taking pictures. Warm tap water was poured into a 1000 ml glass beaker. The temperature was adjusted ˜30° C. by adding warm or cool water as needed. A 500 ml beaker was placed on and zeroed on the scale. About 600 grams of the 30° C. water were poured into the 500 ml beaker. The exact weight of the water was recorded. The weighed water from the 500 ml beaker was poured into the bowl containing 300 grams of food product. The 500 ml beaker was placed back on the scale and re-zeroed, remaining there until soakability test was completed. The food product and water were stirred to make certain all the food was covered or contacted with water. Stirring was repeated every 10 minutes.

Photographs of the food product and water were taken from above and/or from side of bowl, as desired, at 15, 20, 30 and 45 minutes. After 30 or 45 minutes, the remaining free liquid was poured back into the tared 500 ml beaker on the scale, and the weight of the liquid was recorded.

### Soakability Calculation

Initial water−Remaining liquid=Absorbed water

Example: 600 grams−300 grams=300 grams absorbed water

Absorbed water/Initial water×100=% Absorption

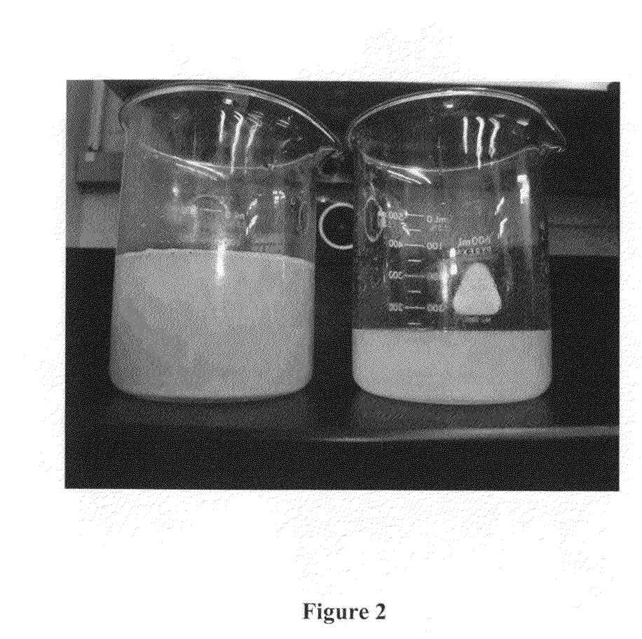

300 grams/600 grams×100=50% Absorption
The results of a typical experiment are depicted in FIG. 2.

### Example 3

### Palatability of “Empty Kibble” Versus “Solid Kibble”

Palatability of empty kibble versus solid traditional kibble was tested in feline and canine panels under controlled conditions.

Parameters measured included food intake for each type of food product offered (e.g. empty versus round kibble), measured daily; and body weight.

Percent consumption is the parameter most used to determine “preference” as it reflects the food most consumed, regardless of actual total (g) consumption:

grams product A consumed/(total grams product A+B consumed)×100=% product A consumed

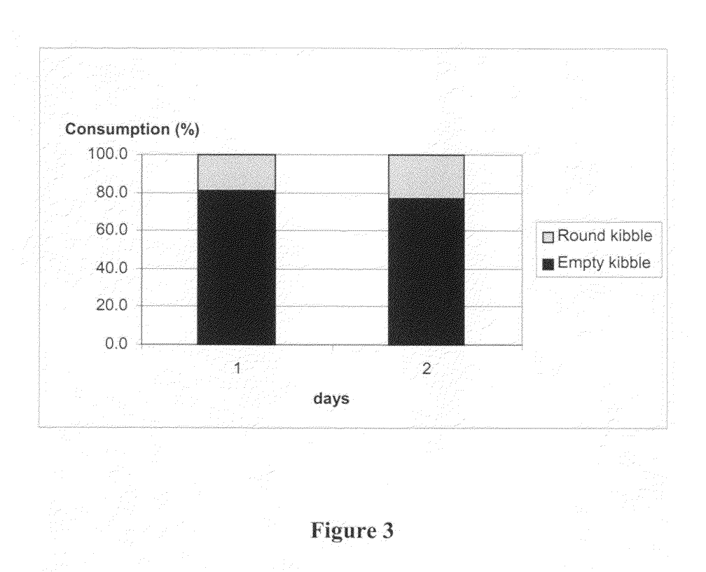

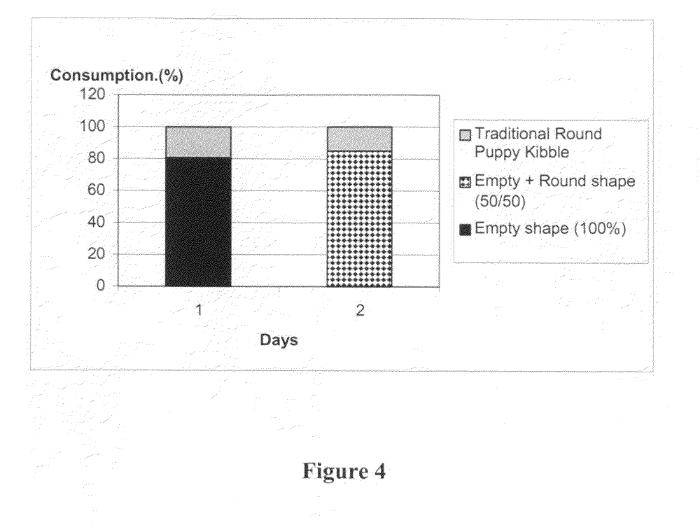

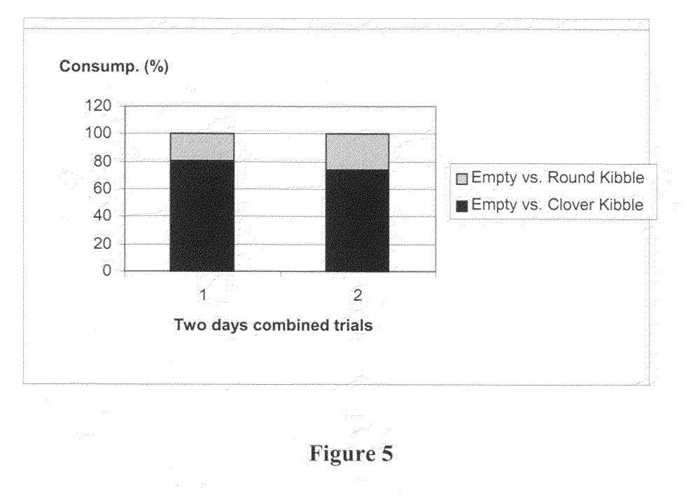

Results are presented in the form of graphs. Results of studies conducted are shown in FIGS. 3, 4 (dogs) and FIG. 5 (cats).

The present invention is not limited to the embodiments described and exemplified above. It is capable of variation and modification within the scope of the appended claims.

What is claimed:

1. An extruded food product comprising a shelf-stable shell at least partially surrounding a hollow core area, wherein the shell comprises an outer surface area and an inner surface area, said surface areas adapted to allow rehydration of the food product upon exposure to a wetting agent, said surface areas accessible to the wetting agent.

2. The food product of claim 1 wherein the rehydration occurs at a faster rate or to a greater extent, or both, than in a comparably formulated food lacking the inner surface area.

3. The food product of claim 2 that retains more of the wetting agent after a predetermined time than does a comparably formulated food lacking the inner surface area.

4-6. (canceled)

7. The food product of claim 1 that is adapted for use by a mammal with a limited ability to chew relative to healthy mammal of the same species.

8-10. (canceled)

11. The food product of claim 1 that is less dense than a comparably formulated food product lacking the inner surface.

12. The food product of claim 1 that requires as much as 50% less energy to break than a comparably formulated food product lacking the inner surface.

13. The food product of claim 1 that has improved palatability over a comparably formulated food product lacking the inner surface.

14. (canceled)

15. The food product of claim 1 wherein the shelf-stable shell partially, but not entirely, surrounds the hollow core area.

16. An extruded food product comprising a shelf-stable shell at least partially but not entirely surrounding a core area, the shell comprising an outer surface area and an inner surface area, said surface areas adapted to allow rehydration of the food product upon exposure to a wetting agent, wherein the core area is at least partially filled with one or more additional ingredients, or a mixture thereof, the additional ingredients being added either during manufacture of the shelf-stable shell, or at a time subsequent to the extrusion of said shell, wherein the food product rehydrates upon exposure to a wetting agent, said wetting agent having at least partial access to both the outer surface area and the inner surface area of the extruded shell.

17. The food product of claim 16 wherein the rehydration occurs at a faster rate or to a greater extent, or both, than in a comparably formulated food lacking the inner surface area.

18. The food product of claim 17 that retains more of the wetting agent after a predetermined time than does a comparably formulated food not adapted to allow access of the wetting agent to the inner surface area.

19. (canceled)

20. The food product of claim 16 wherein at least one of the one or more additional ingredients, or a mixture thereof, are sprayed, stuffed, injected, or pumped into the core defined by the shell.

21-24. (canceled)

25. The food product of claim 16 wherein at least one of the one or more additional ingredients comprises a powder or granular ingredient.

26-27. (canceled)

28. The food product of claim 16 comprising more than two textures, colors, flavors, or a combination thereof.

29. The food product of claim 28 wherein the shell has a moisture content by weight of less than about 14% and a water activity of less than about 0.63.

30. (canceled)

31. The food product of claim 28 wherein the shell has a moisture content by weight of up to about 25%, and further comprises humectants.

32. (canceled)

33. An extruded food product comprising a shelf-stable shell surrounding a core area, wherein the core area is at least partially filled with one or more granular ingredients, or a mixture thereof, the additional ingredients being added during manufacture of the shelf-stable shell.

34. The food product of claim 33 comprising more than two textures, colors, flavors, or a combination thereof.

35. The food product of claim 34 wherein the shell has a moisture content by weight of less than about 14% and a water activity of less than about 0.63.

36. (canceled)

37. The food product of claim 34 wherein the shell has a moisture content by weight of up to about 25%, and further comprises humectants.

28-65. (canceled)
